(19) United States
(12) Patent Application Publication
(10) Pub. No.: US 2006/0280425 A1
(43) Pub. Date: Dec. 14, 2006

(54) Image combining apparatus, image combining method, image combining program, and storage medium

(76) Inventor: Naoki Morita, Hachioji-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/442,051

(22) Filed: May 26, 2006

(30) Foreign Application Priority Data
Jun. 6, 2005 (JP) 2005-165513

(51) Int. Cl. H04N 9/00

(52) U.S. Cl. 386/4

(57) ABSTRACT

An image combining method for an image combining apparatus which stores a plurality of template images and combines a shooting-date-and-time-attached shot image with the template images, the image combining method includes assigning a time attribute representing a period to the template images, extracting the shooting date and time information of the shot image, comparing a period assigned to the templates with the extracted shooting date and time of the shot image and selecting the template images having the period, which includes the shooting date and time, as candidate templates, displaying a list of the selected candidate templates, and selecting a template according to the operation by the user from the list of the displayed candidate templates.

### CROSS-REFERENCE TO RELATED APPLICATIONS

This application is based upon and claims the benefit of priority from prior Japanese Patent Application No. 2005-165513, filed Jun. 6, 2005, the entire contents of which are incorporated herein by reference.

### BACKGROUND OF THE INVENTION

1. Field of the Invention

This invention relates to an image combining technique for combining a shot image with templates.

2. Description of the Related Art

When an image picked up by a digital camera is loaded into a personal computer (PC) or the like and printed out, the image is often combined with the template representing illustration or landscape and the resulting image is printed out.

A wide variety of patterns corresponding to the shooting environment are prepared for the templates. A method of acquiring information about the place and time from the GPS mounted on the camera and searching for a template suitable for the image has been disclosed in Jpn. Pat. Appln. KOKAI Publication No. 2002-10068.

### BRIEF SUMMARY OF THE INVENTION

According to a first aspect of the invention, there is provided an image combining apparatus which stores a plurality of template images and combines a shooting-date-and-time-attached shot image with the template images, the image combining apparatus comprising: a time attribute assigning section which assigns a time attribute representing a period to the template images; a shooting date and time extracting section which extracts the shooting date and time information of the shot image; a first template selecting section which compares a period assigned to the templates by the time attribute assigning section with the shooting date and time of the shot image extracted by the shooting date and time extracting section and selects the template images having the period, which includes the shooting date and time, as candidate templates; a template list displaying section which displays a list of the candidate templates selected by the first template selecting section; and a second template selecting section which selects a desired template from the list of the candidate templates displayed by the template list displaying section.

According to a second aspect of the invention, there is provided an image combining method for an image combining apparatus which stores a plurality of template images and combines a shooting-date-and-time-attached shot image with the template images, the image combining method comprising: a time attribute assigning step of assigning a time attribute representing a period to the template images; a shooting date and time extracting step of extracting the shooting date and time information of the shot image; a first template selecting step of comparing a period assigned to the templates in the time attribute assigning step with the shooting date and time of the shot image extracted in the shooting date and time extracting step and selecting the template images having the period, which includes the shooting date and time, as candidate templates; a template list displaying step of displaying a list of the candidate templates selected in the first template selecting step; and a second template selecting step of selecting a template according to the operation by the user from the list of the candidate templates displayed in the template list displaying step.

According to a third aspect of the invention, there is provided a program which runs on an image combining apparatus that stores a plurality of template images and combines a shooting-date-and-time-attached shot image with the template images, the program comprising the processes of: assigning a time attribute representing a period to the template images; extracting the shooting date and time information of the shot image; comparing a period assigned to the templates with the extracted shooting date and time of the shot image and selecting the template images having the period, which includes the shooting date and time, as candidate templates; displaying a list of the selected candidate templates; and further selecting a template according to the operation by the user from the displayed list of the candidate templates.

According to a fourth aspect of the invention, there is provided a recording medium which stores a program running on an image combining apparatus that stores a plurality of template images and combines a shooting-date-and-time-attached shot image with the template images, the program including: a time attribute assigning step of assigning a time attribute representing a period to the template images; a shooting date and time extracting step of extracting the shooting date and time information of the shot image; a first template selecting step of comparing a period assigned to the templates in the time attribute assigning step with the shooting date and time of the shot image extracted in the shooting date and time extracting step and selecting the template images having the period, which includes the shooting date and time, as candidate templates; a template list displaying step of displaying a list of the candidate templates selected in the first template selecting step; and a second template selecting step of selecting a template according to the operation by the user from the list of the candidate templates displayed in the template list displaying step.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 shows a list display screen for templates;

FIG. 2 is a block diagram showing the configuration of an image combining apparatus;

FIG. 3 shows a linkage between tables and processing programs;

FIG. 4 shows the contents of a calendar table;

FIG. 5 shows the contents of a time table;

FIG. 6 shows an example of a time category;

FIG. 7 shows the contents of a calendar category setting table;

FIG. 8 shows an example of keywords;

FIG. 9 is a flowchart to help explain a general procedure for a template registering process;

FIG. 10 is a flowchart to help explain a procedure for a template selecting process; and

FIG. 11 is a flowchart to help explain a procedure for a template selecting process.

### DETAILED DESCRIPTION OF THE INVENTION

The basic idea of a template selecting method according to an embodiment of the present invention will be explained.

In the invention, templates are caused to correspond to images on a day basis, a week basis, a month basis, and a season basis. A day means one of the days ranging from January 1 to December 31. A week means one of the weeks ranging from the first week of January to the fifth week of December. A month means one of the months ranging from January to December. A season is, for example, one of spring, summer, autumn, and winter. The days, weeks, months, seasons are referred to as calendar categories.

One template is caused to correspond to only one of the day, week, month, and season calendar categories. It is not caused to correspond to the latter redundantly.

Therefore, specifying a day of the month makes it possible to identify a template corresponding to the day. In addition, specifying a week of the month makes it possible to identify a template corresponding to the week. Specifying a month makes it possible to identify a template corresponding to the month. Moreover, specifying a season makes it possible to identify a template corresponding to the season.

Furthermore, a template is caused to correspond to “time.” “Time” dealt with in the present invention does not mean such actual time as XX:YY, but means an ambiguous time zone, such as dawn, morning, daytime, or evening. The “time” is referred to as a time category.

Specifying the “time” makes it possible to identify a template corresponding to the “time.” In the shot image, shooting date and time and a keyword, or scene shooting setting information, are recorded as attendant information. The shooting date in the attendant information correspond to the aforementioned day, week, month, and season. Moreover, the hours: minutes shooting in the attendant information correspond to the aforesaid “time.” Therefore, it is possible to extract the corresponding template according to the shooting date and time in the attendant information.

Next, using a concrete example, the operation including up to selecting a template will be explained.

For example, suppose an image obtained by photographing a landscape of a South Pacific resort is selected. The shooting date and time is 14:18:06 on Aug. 3, 2004.

First, from the shooting date, a template corresponding to the calendar category “day, week, month, season” is extracted. Then, according to the shooting time 14:18:06, “daytime” is identified from the time category “morning, daytime, evening, . . . ” and a template registered in the time category is searched for. Then, a template registered in both of the time category and calendar category is extracted.

In the extraction, a template in a narrower calendar category is given priority. Specifically, a template is extracted in this order: day>week>month>season. For example, if a common template was registered on August 3, the template is used. If a common template was not registered on August 3 and a common template was registered in the first week of August, the template is used. As described above, giving priority to a template with a narrower scope in selection enables a more suitable template to be extracted.

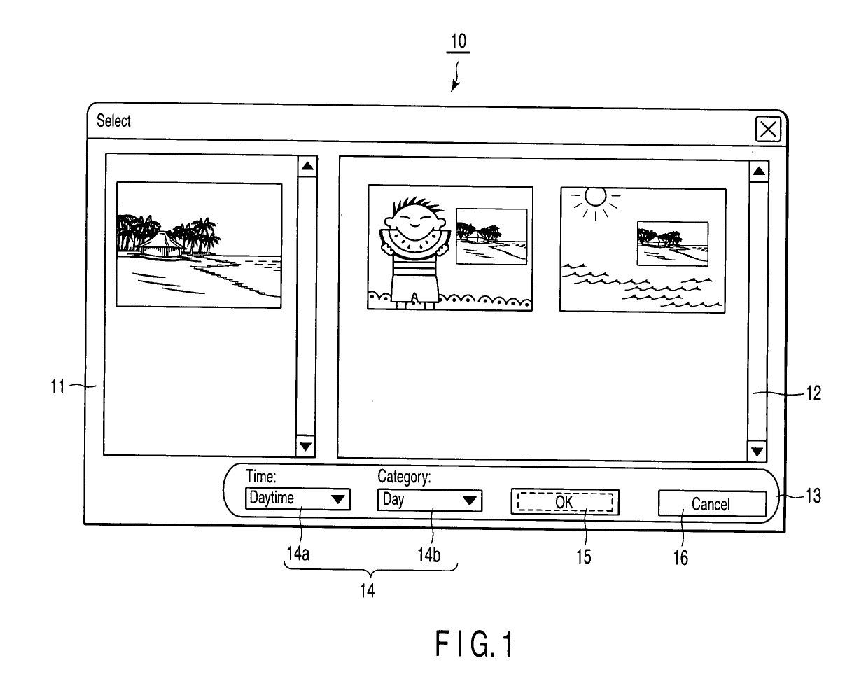

FIG. 1 shows a list display screen for templates.

In the list display screen 10, an image display area 11, a template display area 12, and an operation area 13 are provided. In the operation area 13, there are provided a switching box 14, an OK button 15, and a cancel button 16.

In the image display area 11, an image arbitrarily selected by the user is displayed. In the template display area 12, a template extracted on the basis of shooting date and time information about the image is displayed together with the image.

The user can select the desired one from the templates displayed in the template display area 12.

Using a mouse, the user clicks the desired template and operates the OK button 15, thereby selecting the template.

When the desired template is not displayed in the template display area 12, the user operates the switching box 14, which enables the user to switch the selection of templates.

A time switching box 14a of FIG. 1 shows that “daytime” has been selected as the time category. A calendar switching box 14b shows that “day” has been selected as the calendar category.

When the user selects “morning” as the time category in the time switching box 14a, a template satisfying the condition is selected and displayed in the template display area 12. In addition, when the user selects “month” as the calendar category in the calendar switching box 14b, a template satisfying the condition is selected and displayed in the template display area 12.

When a keyword has been recorded in the attendant information about the shot image, a calendar category is identified using the keyword. For instance, when “firework” has been set as the keyword, “season” is specified for the calendar category on the basis of a table previously provided.

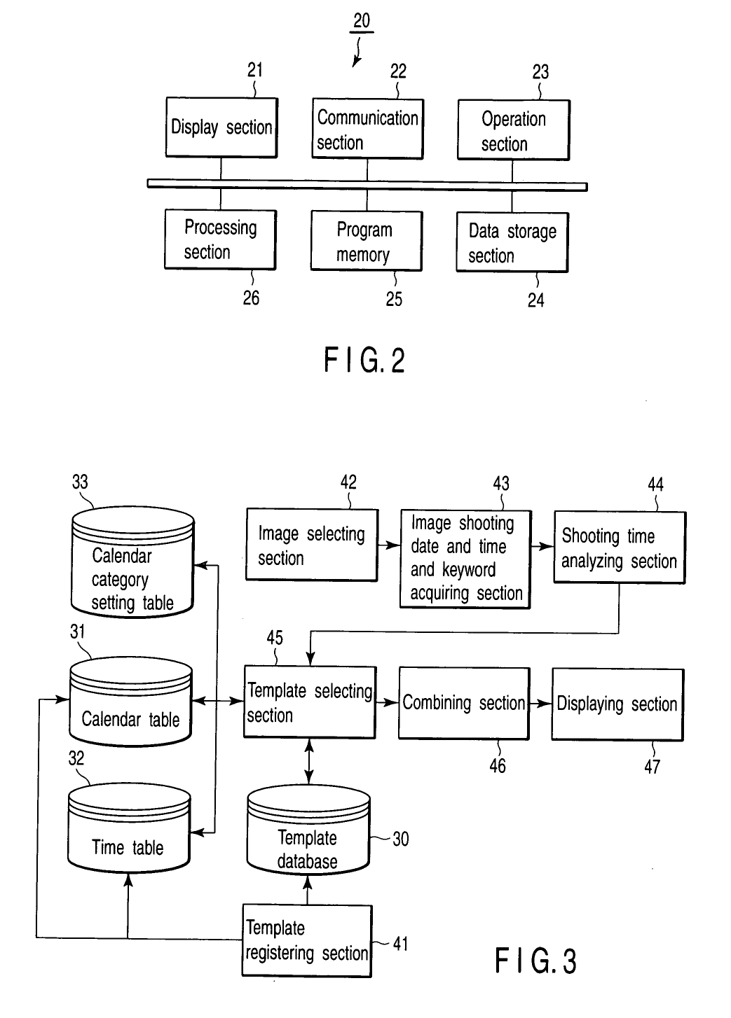

The configuration of the image combining apparatus 20 to realize the template selecting operation will be explained with reference to a block diagram shown in FIG. 2.

The image combining apparatus 20 includes a display section 21, a communication section 22, an operation section 23, a data storage section 24, a program memory 25, and a processing section 26.

The display section 21 is a CRT or a TFT liquid-crystal display which displays an image or the like. The communication section 22 exchanges data with an external unit (not shown). The operation section 23 is an input device for receiving an operation instruction input by the user, such as a keyboard or a mouse. The data storage section 24 stores necessary data for the operation of selecting the image transmitted from an external unit (not shown) and templates. In the program memory 25, a program operating on the image combining apparatus 20 is recorded. The processing section 26 controls the operation of the image combining apparatus 20 comprehensively.

FIG. 3 shows the linkage between individual tables stored in the data storage section 2 and individual processing programs stored in the program memory 25.

The data storage section 24 includes a template database 30, a calendar table 31, a time table 32, and a calendar category setting table 33.

In the template database 30, images used as templates are stored. Template IDs are assigned as identification data to the individual templates.

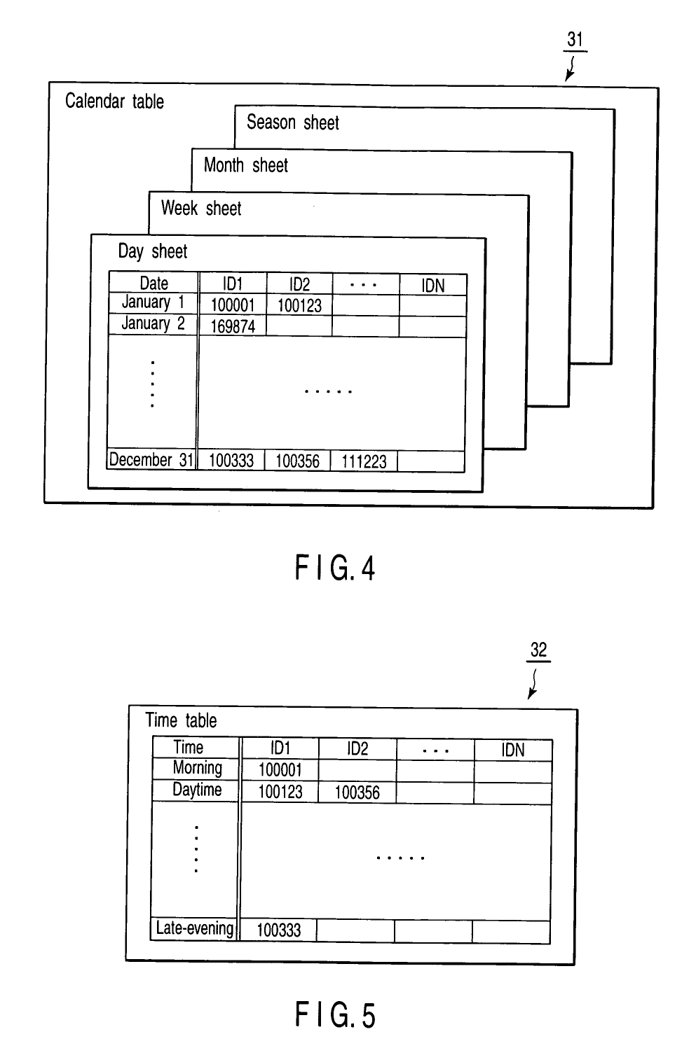

FIG. 4 shows the contents of the calendar table 31. In the calendar table 31, template IDs are stored in such a manner that they correspond to the respective calendar categories. In the calendar table 31, there are provided a day sheet, a week sheet, a month sheet, and a season sheet. The template IDs are stored in such a manner that they correspond to the calendar elements of the respective sheets. As described above, one template ID is recorded in any one of the day sheet, week sheet, month sheet, and season sheet, and is never recorded redundantly.

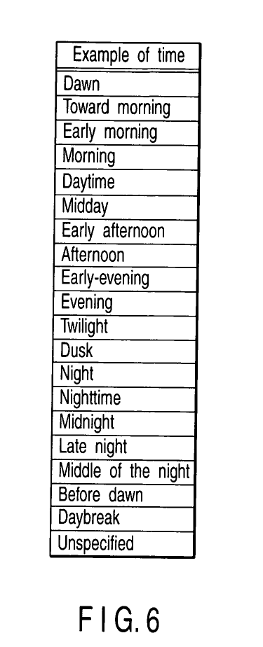

FIG. 5 shows the contents of the time table 32. In the time table 32, template IDs are stored in such a manner that they correspond to the individual time categories. FIG. 6 shows an example of the time categories. The time categories of FIG. 6 are illustrative and not restrictive. For instance, the time categories may be classified in other ways.

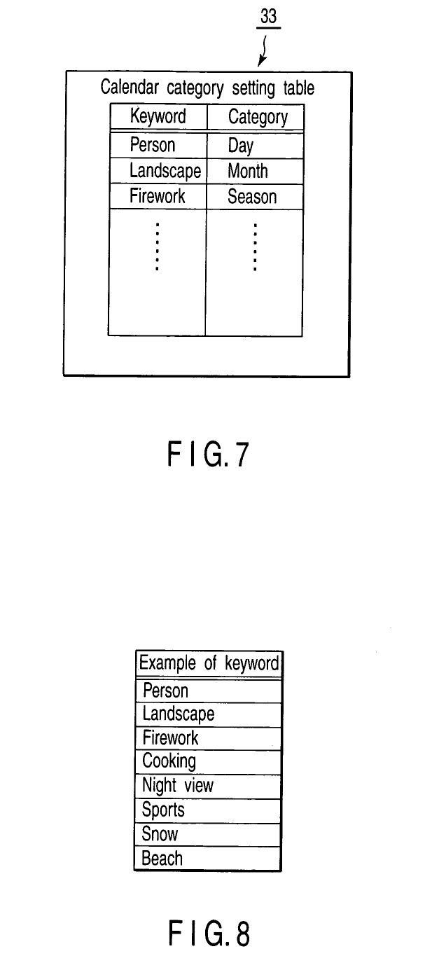

FIG. 7 shows the contents of a calendar category setting table 33. In the calendar category setting table 33, calendar categories corresponding to the individual keywords are stored. FIG. 8 shows an example of keywords. The keywords of FIG. 8 are illustrative and not restrictive. For instance, the keywords may be classified in other ways.

Next, the individual processing programs shown in FIG. 3 will be explained.

A template registering section 41 not only reads template images and stores them in the template database 30 but also stores the template IDs in the corresponding categories of the calendar table 31 and time table 32.

An image selecting section 42 is a user interface which helps the user select the desired image. An image shooting date and time and keyword acquiring section 43 identifies a calendar category on the basis of the shooting date and time, or attendant information, or the keywords. A shooting time analyzing section 44 identifies a time category on the basis of the shooting time. A template selecting section 45 refers to each table on the basis of the identified calendar category and time category and selects candidate templates. A combining section 46 combines the selected template with the image. A displaying section 47 displays the combined images in list form.

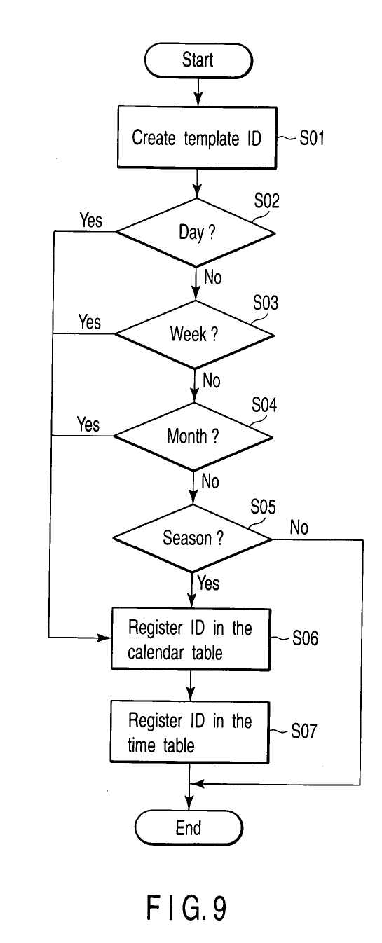

Referring to FIGS. 9 to 11, the procedure for realizing the image combining operation will be explained. The procedure explained below is the main part of the procedure of the image combining method. Therefore, the functions explained in FIG. 1 to FIG. 8 are included in the image combining method, even if some of them are not included in the explanation below.

FIG. 9 is a flowchart to help explain the basic procedure for a template registering process.

When the user starts up the template registering section 41 and specifies an image to be used as a template, the template registering section 41 creates a unique template ID in step S01 and allocates the template ID to the template. The image used as the template is not limited to the images stored in the template database 30 and may be an image taken in from an external unit (not shown) via the communication section 22.

Next, the user selects day, week, month, and season, or the category to which the template belongs, from a combo box displayed.

If Yes in step S02, or if the selected category is day, the shooting day is identified from the shooting date of the template in step S06 and the template ID is registered in the corresponding day of the day sheet of the calendar table 31.

If Yes in step S03, or if the selected category is week, the shooting week is identified from the shooting date of the template in step S06 and the template ID is registered in the corresponding week of the week sheet of the calendar table 31.

If Yes in step S04, or if the selected category is month, the shooting month is identified from the shooting date of the template in step S06 and the template ID is registered in the corresponding month of the month sheet of the calendar table 31.

If Yes in step S05, or if the selected category is season, the season is identified from the shooting date of the template in step S06 and the template ID is registered in the corresponding season of the season sheet of the calendar table 31.

After the template ID has been registered in the calendar table 31, “time” is identified from the shooting time of the template and the template ID is registered in the corresponding time of the time table 32.

While in the embodiment, the storage positions of the calendar table 31 and time table 32 have been determined on the basis of the shooting date, the storage positions of the calendar table 31 and time table 32 may be determined on the basis of the user's specification.

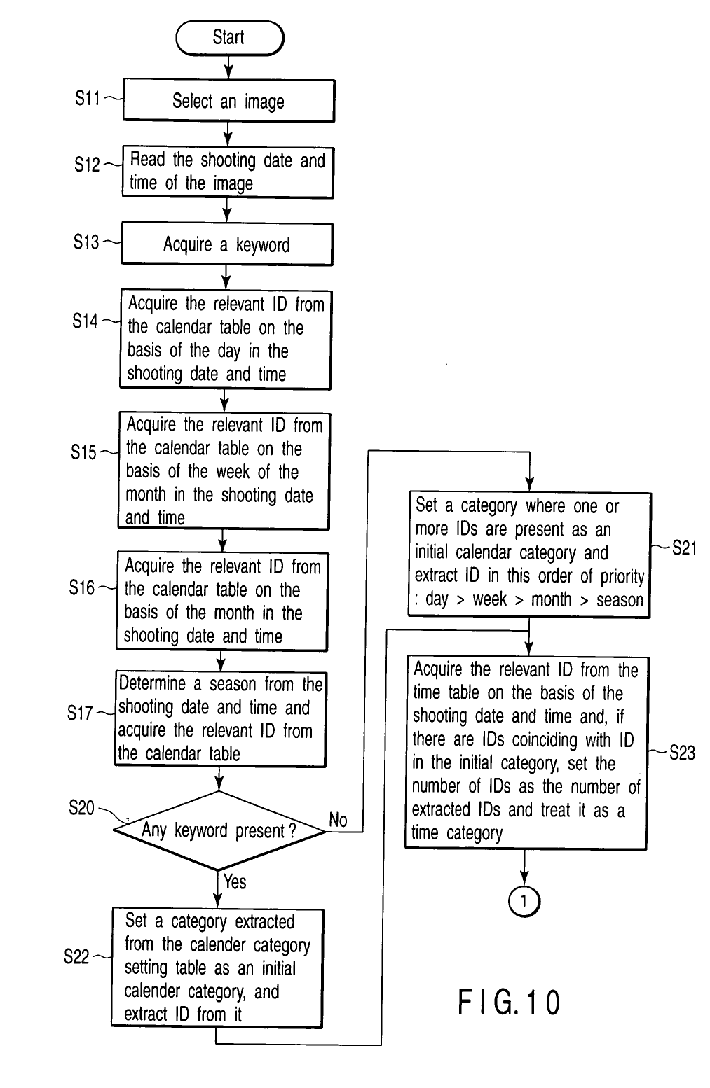

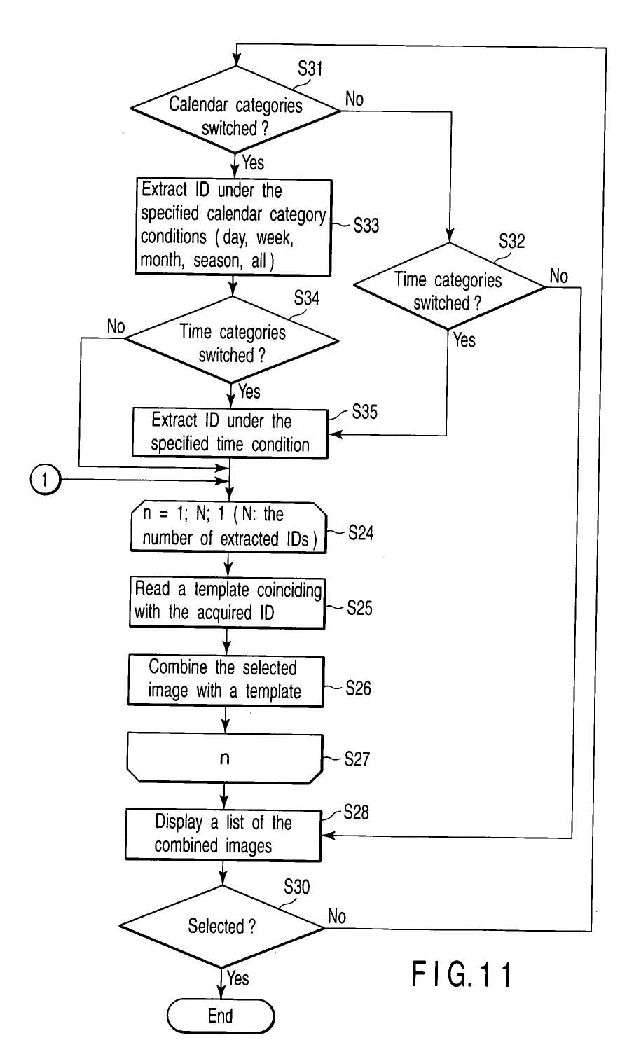

FIGS. 10 and 11 are flowcharts for an image combining process.

In step S11, the image selecting section 42 selects a desired image. The image to be selected may be an image recorded in the template database 30 or an image transmitted via the communication section 22 from the outside.

Next, the image shooting date and time and keyword acquiring section 43 reads the shooting date and time of the image from the attendant information on the image in step S12 and acquires a keyword in step S13.

Suppose the shooting date and time are always recorded in the image. However, the keyword may not be recorded in the image.

In step S14, the shooting time analyzing section 44 searches for the day sheet of the calendar table 31 and retrieves the template ID recorded in the shooting day.

In step S15, the shooting time analyzing section 44 searches for the week sheet of the calendar table 31 and retrieves the template ID recorded in the shooting week.

In step S16, the shooting time analyzing section 44 searches for the month sheet of the calendar table 31 and retrieves the template ID recorded in the shooting month.

In step S17, the shooting time analyzing section 44 searches for the season sheet of the calendar-table 31 and retrieves the template ID recorded in the corresponding season on the basis of the shooting date and time.

In step S20, a check is made to see if a keyword has been allocated to the image.

If No in step S20, or if no keyword has been assigned to the image, an initial category is extracted on the basis of the calendar table 31 in step S21. Specifically, a search is made for a category where one or more template IDs have been recorded on the corresponding date in this order of priority: day sheet>week sheet>month sheet>season sheet. Then, the retrieved category is used as the initial category.

If Yes in step S20, or if a keyword has been assigned to the image, the calendar category setting table 31 is searched and the category corresponding to the keyword is extracted in step S22. Then, the category is used as the initial category.

In step S23, “time” is identified from the time in the shooting date and time, and the template ID registered in the corresponding time of the time table 32 is extracted. Then, the template ID in the initial category is collated with the template IDs registered in the corresponding time of the time table 32. The template IDs coinciding with the former and the number N of the template IDs are taken out.

The combining section 46 reads in the corresponding template on the basis of the template IDs coinciding with the one in the initial category in step S24 to step S27 of FIG. 11 and combines the template with the image. In step S28, the displaying section 47 displays a list of the combined images on the display section 21.

The user can select a desired template from the list of the combined images displayed. That is, the user can select the desired template by selecting the desired image from the list of images shown in FIG. 1 and pressing the OK button.

On the other hand, if No in step S30, or if the desired template is absent, it is possible to switch calendar categories or time categories again and display a list of combined images again. The switching of calendar categories or time categories is done by operating the time switching box 14a or calendar switching box 14b shown in FIG. 1.

If Yes in step S31, or if calendar categories are switched, the template selecting section 45 extracts the category ID corresponding to the specified calendar category condition, for example, day, week, month, season, or all.

If Yes in step S34, or if time categories have been switched, the template selecting section 45 extracts the category corresponding to the condition for the specified time category. Then, the template IDs satisfying the conditions for both of the specified calendar category and time category and the number N of the template IDs are extracted.

Then, the image list displaying process and selecting process in step S24 and subsequent steps are executed.

If No in step S34, or if time categories have not been switched, the template IDs satisfying the condition for the specified calendar category and the number of N of the template IDs are extracted.

Then, the image list displaying process and selecting processes in step S24 and subsequent steps are extracted.

On the other hand, if No in step S31 and Yes in step S32, or if only time categories have been switched, the category ID satisfying the condition for the specified time category is extracted. Then, the template IDs satisfying the conditions for both of the specified calendar category and time category and the number N of the template IDs are extracted.

Then, the image list displaying process and selecting process in step S24 and subsequent steps are executed.

In the embodiment explained above, templates are selected on the basis of the date and time that the image was shot, and the selected templates are combined with the image, thereby displaying a list of the combined images.

The list displays can be switched according to the following categories: day, week, month, season, and all. Moreover, the list displays can be switched according to time categories using the concept of time as a reference.

Furthermore, it is possible to specify a calendar category from the keyword attached to the image.

Accordingly, it is possible to reduce the trouble of selecting a template suitable for the selected image.

Each function explained in the embodiment may be configured using hardware or may be realized using software by causing a computer to read a program in which each function has been written. Moreover, each function may be configured to switch between software and hardware as needed.

Furthermore, each function may be realized by causing a computer to read a program stored in a recording medium (not shown). The recording medium of the embodiment may use any recording format, as long as a program can be recorded in the medium and a computer can read the program from the medium.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. An image combining apparatus which stores a plurality of template images and combines a shooting-date-and-time-attached shot image with the template images, the image combining apparatus comprising:
a time attribute assigning section which assigns a time attribute representing a period to the template images;
a shooting date and time extracting section which extracts the shooting date and time information of the shot image;
a first template selecting section which compares a period assigned to the templates by the time attribute assigning section with the shooting date and time of the shot image extracted by the shooting date and time extracting section and selects the template images having the period, which includes the shooting date and time, as candidate templates;
a template list displaying section which displays a list of the candidate templates selected by the first template selecting section; and
a second template selecting section which selects a desired template from the list of the candidate templates displayed by the template list displaying section.

2. The image combining apparatus according to claim 1, further comprising an image combining section which combines the shot image with each of the candidate templates selected by the first template selecting section,
wherein the template list displaying section further includes a combined image list displaying section which displays a list of the combined images of the shot image and the candidate template images produced by the image combining section.

3. The image combining apparatus according to claim 2,
wherein the time attribute assigned to the template images by the time attribute assigning section are a time zone and a period represented by season, month, week, or day.

4. The image combining apparatus according to claim 3,
wherein the first template selecting section selects the templates on the basis of the time zone and the period represented by any one of the season, month, week, and day.

5. The image combining apparatus according to claim 3, further comprising a display switching section which switches lists displayed by the template list displaying section by changing the specification of the period attached to the template images.

6. The image combining apparatus according to claim 4,
wherein the shot image is further given at least one keyword,
wherein when the at least one keyword is given to the shot image the template list displaying section identifies the period of the shot image on the basis of the at least one keyword given to the shot image and makes an initial display of a list of templates on the basis of the identified period.

7. An image combining method for an image combining apparatus which stores a plurality of template images and combines a shooting-date-and-time-attached shot image with the template images, the image combining method comprising:
a time attribute assigning step of assigning a time attribute representing a period to the template images;
a shooting date and time extracting step of extracting the shooting date and time information of the shot image;
a first template selecting step of comparing a period assigned to the templates in the time attribute assigning step with the shooting date and time of the shot image extracted in the shooting date and time extracting step and selecting the template images having the period, which includes the shooting date and time, as candidate templates;
a template list displaying step of displaying a list of the candidate templates selected in the first template selecting step; and
a second template selecting step of selecting a template according to the operation by the user from the list of the candidate templates displayed in the template list displaying step.

8. The image combining method according to claim 7, further comprising an image combining step of combining the shot image with each of the candidate templates selected in the first template selecting step,
wherein the template list displaying step further includes a combined image list displaying step of displaying a list of the combined images of the shot image and the candidate templates produced in the image combining step.

9. The image combining method according to claim 8,
wherein the time attribute assigned to the template images in the time attribute assigning step are a time zone and a period represented by season, month, week, or day.

10. The image combining method according to claim 9,
wherein the first template selecting step selects the candidate templates on the basis of the time zone and the period represented by any one of the season, month, week, and day.

11. The image combining method according to claim 9, further comprising a display switching step of switching lists displayed in the template list displaying step by changing the specification of the period attached to the template images.

12. The image combining method according to claim 10,
wherein the shot image is further given at least one keyword,
wherein when the at least one keyword is given to the shot image the template list displaying step identifies the period of the shot image on the basis of the at least one keyword given to the shot image and makes an initial display of a list of templates on the basis of the identified period.

13. A program which runs on an image combining apparatus that stores a plurality of template images and combines a shooting-date-and-time-attached shot image with the template images, the program comprising the processes of:
assigning a time attribute representing a period to the template images;
extracting the shooting date and time information of the shot image;
comparing a period assigned to the templates with the extracted shooting date and time of the shot image and selecting the template images having the period, which includes the shooting date and time, as candidate templates;
displaying a list of the selected candidate templates; and
further selecting a template according to the operation by the user from the displayed list of the candidate templates.

14. The program according to claim 13, further comprising a process of combining the shot image with each of the selected candidate templates,
wherein the template list displaying process displays a list of the combined images of the shot image and the candidate templates.

15. The program according to claim 14, wherein the time attribute assigned to the template images are a time zone and a period represented by season, month, week, or day.

16. The program according to claim 15,
wherein the candidate templates are selected on the basis of the time zone and the period represented by any one of the season, month, week, and day.

17. The program according to claim 15, further comprising a process of switching the displayed lists of candidate templates by changing the specification of the period attached to the template images.

18. The program according to claim 16,
wherein the shot image is further given at least one keyword,
wherein when the at least one keyword is given to the shot image the template list displaying process identifies the period of the shot image on the basis of the at least one keyword given to the shot image and makes an initial display of a list of the templates on the basis of the identified period.

19. A recording medium which stores a program running on an image combining apparatus that stores a plurality of template images and combines a shooting-date-and-time-attached shot image with the template images, the program including:
a time attribute assigning step of assigning a time attribute representing a period to the template images;
a shooting date and time extracting step of extracting the shooting date and time information of the shot image;
a first template selecting step of comparing a period assigned to the templates in the time attribute assigning step with the shooting date and time of the shot image extracted in the shooting date and time extracting step and selecting the template images having the period, which includes the shooting date and time, as candidate templates;
a template list displaying step of displaying a list of the candidate templates selected in the first template selecting step; and
a second template selecting step of selecting a template according to the operation by the user from the list of the candidate templates displayed in the template list displaying step.

20. The recording medium according to claim 19,
wherein the program further comprises an image combining step of combining the shot image with each of the selected candidate templates,
wherein the template list displaying step displays a list of the combined images of the shot image and the candidate templates produced in the image combining step.
